(19) United States
(12) Patent Application Publication
(10) Pub. No.: US 2026/0367601 A1
(43) Pub. Date: Nov. 19, 2026

(54) APPARATUS AND METHODS FOR ARTIFICIAL INTELLIGENCE CONTROL OF MANUFACTURING SYSTEMS

(71) Applicant: Fisher-Rosemount Systems, Inc., Round Rock, TX (US)

(72) Inventors: Kebra Kay Tynan, Cedar Park, TX (US); Cristopher Ian Sarmiento Uy, Round Rock, TX (US); Kheneahm Hearc Gold Actub Ares, Austin, TX (US)

(21) Appl. No.: 19/678,633

(22) Filed: May 15, 2026

Related U.S. Application Data
(60) Provisional application No. 63/807,201, filed on May 16, 2025.

(51) Int. Cl. G05B 19/042

(52) U.S. Cl. CPC G05B 19/0426; G05B 2219/40628

(57) ABSTRACT

Apparatus and methods for artificial intelligence control of manufacturing systems are disclosed. An example system includes a control device associated with a process control system; machine-readable instructions; and at least one programmable circuit to execute the machine-readable instructions to execute an artificial intelligence model using a batch record to form a data structure including recipe sections and content within the respective recipe sections, the data structure defining a digital recipe; and cause the control device to operate one or more field devices in the process control system based on the digital recipe.

### RELATED APPLICATION

This patent claims the benefit of U.S. Provisional Patent Application No. 63/807,201, which was filed on May 16, 2025. U.S. Provisional Patent Application No. 63/807,201 is hereby incorporated herein by reference in its entirety. Priority to U.S. Provisional Patent Application No. 63/807,201 is hereby claimed.

### FIELD OF THE DISCLOSURE

This disclosure relates generally to process control systems and, more particularly, to apparatus and methods for artificial intelligence control of manufacturing systems.

### BACKGROUND

A manufacturing execution system (MES) provides for management and monitoring of a manufacturing process implemented via a process control system.

### BRIEF DESCRIPTION OF THE DRAWINGS

FIG. 1 is a block diagram of an example system in which example production control circuitry operates to provide for artificial intelligence control of manufacturing processes.

FIG. 2 is a block diagram of an example implementation of model training circuitry of FIG. 1.

FIG. 3 is a block diagram of an example implementation of the production control circuitry of FIG. 1.

FIGS. 4–6 illustrate example outputs of the production control circuitry of FIG. 3.

FIG. 7 is a flowchart representative of example machine-readable instructions and/or example operations that may be executed, instantiated, and/or performed by example programmable circuitry to implement the model training circuitry of FIG. 2.

FIG. 8 is a flowchart representative of example machine-readable instructions and/or example operations that may be executed, instantiated, and/or performed by example programmable circuitry to implement the production control circuitry of FIG. 3.

FIG. 9 is a block diagram of an example processing platform including programmable circuitry structured to execute, instantiate, and/or perform the example machine-readable instructions and/or perform the example operations of FIG. 8 to implement the production control circuitry of FIG. 3.

In general, the same reference numbers will be used throughout the drawing(s) and accompanying written description to refer to the same or like parts. The figures are not necessarily to scale.

### DETAILED DESCRIPTION

A process control system, such as those used in chemical, pharmaceutical, and/or other processes or process plant(s), typically includes one or more process controllers communicatively coupled to one or more field devices. In such systems, the field devices, including, for example, valves, valve positioners, switches and/or sensors (e.g., temperature, pressure, level and flow rate sensors), are located within the process environment and perform process control, alarm and/or management functions such as opening or closing valves, measuring process parameters, etc.

The process control system can control the field devices as a part of a manufacturing process to produce one or more end products, such as, a pharmaceutical drug. A manufacturing execution system (MES) typically includes application(s) (e.g., software application(s)) to enable a user to monitor and manage the manufacturing process (e.g., to monitor operation of the field devices, to manage workflows). A user can also manage a recipe that is used to make the product (e.g., a drug) via the MES. For example, a digital recipe can be provided to the MES to automate workflows and provide for consistency in manufacturing.

In the context of, for instance, pharmaceutical drug manufacturing, a batch record for a drug includes product information identifying the product to be created using the recipe, instructions or tasks performed, a bill of materials that lists components and raw materials used to produce a speciﬁc product or batch, a bill of equipment that identifies the equipment used to execute the drug recipe, and signatures of personnel involved in the production of the product batch. However, batch records are typically non-standardized or unstructured documents, in that the content or format of the document can vary between manufacturers or products. Thus, defining a digital recipe in an MES based on a batch record is resource-intensive and introduces opportunities for error when manually inputting data from the batch records into the MES.

Also, in an MES, the bill of materials links the materials for the drug to the manufacturing process to produce the drug. Typically, the bill of materials is created and associated with manufacturing orders in a manual fashion by a user (e.g., a recipe author or order creator/executor). For instance, to create a recipe in an MES, the recipe author defines all materials (raw, intermediate, and ﬁnished goods) in a material management application, creates a recipe via a recipe authoring application, and then manually associates (i.e., maps) individual materials and quantities of those materials to the recipe. Similarly, creating a bill of equipment can involve identifying, for example, the equipment to be used and the availability of such equipment. These manual processes can be time-consuming and prone to errors due to the manual input of information in the MES.

Disclosed herein are example systems, apparatus, and methods for providing artificial intelligence (AI) control of manufacturing systems. In examples disclosed herein, production control circuitry executes AI models to generate recipes or portions thereof, such as a bill of materials identifying raw materials and quantities for manufacturing a product. Some examples disclosed herein use AI to generate digital recipes from manufacturing batch records. Example AI models disclosed herein are trained to analyze unstructured or non-standardized documents such as batch records and to generate a digital recipe based on the analysis. The digital recipe can be used to control one or more devices (e.g., field devices) in the process control system. Rather than simply extracting data from a batch record, examples disclosed herein infer context using the data extracted from the batch record and synthesize the data based on the contextual analysis to generate a digital recipe. In examples disclosed herein, the recipe outputs of the AI models comply with, for example, International Society of Automation (ISA) standards for digital recipes (e.g., ISA-88 for batch process control).

Examples disclosed herein also use AI to generate content for one or more sections of a given recipe, such as a bill of materials. Based on the analysis of the batch record and/or user inputs indicating, for example, a recipe name and/or a description of the end product to be manufactured, examples disclosed herein execute AI models to generate a bill of materials identifying raw materials and quantities for manufacturing a product. In some examples, production control circuitry can use AI to generate a bill of equipment identifying assemblies, subassemblies, etc. in a process control system to produce the end product. Example AI models disclosed herein can be customized based on industry specifications, regulations, etc. Further, when generating the recipe or portions of thereof (e.g., a bill of material), examples disclosed herein can account for conditions in the process control environment (e.g., availability of consumables such as packaging materials, materials to facilitate chemical reactions between the materials of the recipe, availability of field devices, etc.). Thus, examples disclosed herein provide for end-to-end recipe generation, including contextually relevant AI-driven outputs that are used to control the manufacturing process. As a result, examples disclosed herein increase efficiency and accuracy in the manufacturing process by removing manual tasks such as entry of materials and recipe mapping that can introduce errors into the process. Further, examples disclosed herein can reduce the time and resources to validate and test recipes (e.g., from years to weeks) in view of the AI-driven analysis with respect to, for example, generating a bill of materials.

In some examples, the disclosed AI models can be used to adjust recipes with respect to one or more parameters, instructions, etc. Based on the training and inputs such as available equipment and materials, the AI models can generate adjustment(s) to the recipe with increased accuracy and efficiency as compared to manual adjustments.

Although examples disclosed herein are primarily discussed in the context of using AI to generate a recipe for a pharmaceutical drug for use in a manufacturing execution system, examples disclosed herein can be used in connection with other aspects of pharmaceutical drug manufacturing. Further, examples disclosed herein can be used with other industries, other end products, other manufacturing processes, and/or systems, etc.

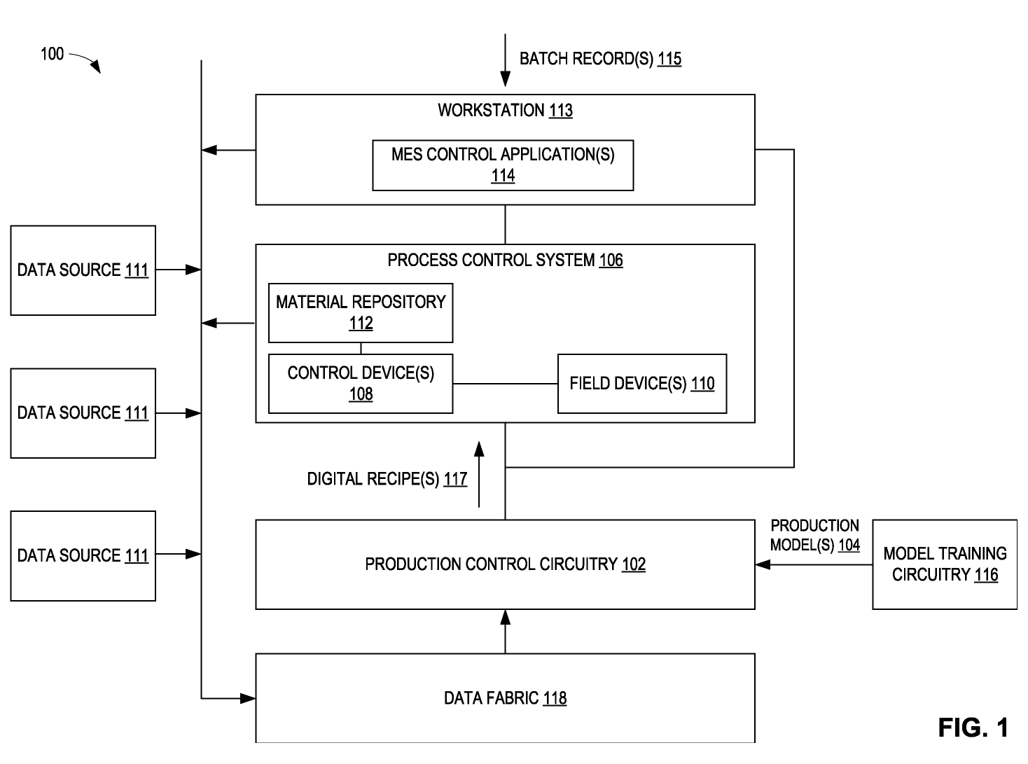

FIG. 1 is a block diagram of an example system 100 in which an example production control circuitry 102 operates to execute AI-based production model(s) 104 to generate outputs for use in a manufacturing process, such as a manufacturing recipe that includes a bill of materials, a bill of equipment, and work instructions. The manufacturing process can be implemented by a process control system 106. The production control circuitry 102 of FIG. 1 can be implemented locally (e.g., by one or more programmable circuits in the process control environment), virtually (e.g., in the cloud, by a virtual machine), or a combination thereof.

The example process control system 106 of FIG. 1 includes one or more control devices 108 (e.g., programmable circuit(s)) communicatively coupled to one or more field devices 110 (e.g., valves, actuators, sensors). The control device(s) 108 execute algorithms to implement control strategies, processes, and/or routines via the field device(s) 110. The control device(s) 108 are in communication with a material repository 112 (e.g., a data store) that identifies available materials and quantities for use in manufacturing a product (e.g., a drug) and monitors usage of the materials by the process control system 106.

In the example of FIG. 1, a workstation 113 is in communication with the control device(s) 108 as part of a manufacturing execution system (MES). The workstation 113 includes one or more MES control application(s) 114 installed thereon to enable user(s) to interact with the control device(s) 108 and the material repository 112 (e.g., via graphical user interface(s)). In the example of FIG. 1, the MES control application(s) 114 and/or the control device(s) 108 can communicate with one or more data sources 111, such as electronic lab notebook(s), laboratory information management systems (LIMS), document management systems, etc.

In the example of FIG. 1, the production model(s) 104 executed by the production control circuitry 102 are AI-based model(s) (e.g., machine learning model(s)) that are generated (e.g., trained) by the model training circuitry 116. As disclosed herein, the production model(s) 104 can be trained using, for example, large language models and industry-specific models or data (e.g., a BioBERT model for language processing in the biomedical industry).

In examples disclosed herein, a user can provide one or more batch records 115 (e.g., paper copies or digital copies) via the MES control application(s) 114. The AI-production model(s) 104 analyze the batch record(s) 115 to generate a digital recipe 117 that is to be executed via the process control system 106. The production control circuitry 102 executes the production model(s) 104 to extract content from the batch record(s) 115, to infer context from the content (e.g., by interpreting work instructions), and to generate and output the digital recipe 117 in a structured format (e.g., in compliance with formatting standards (e.g., ISA standards) for digital recipes). In some examples, a user can review the digital recipe 117 (e.g., via the MES control application(s) 114) and adjust the recipe and/or portions thereof. In some example, the user approves the recipe and/or portions thereof prior to execution of the recipe 117 by the process control system 106 (e.g., to comply with human-in-the-loop standards such as those defined by the United States Food and Drug Administration).

The production model(s) 104 use the content of the batch record(s) 115 to identify sections or components of the digital recipe, such as a bill of materials, a bill of equipment, work instructions, parameters, signatures, etc. In some examples disclosed herein, the production model(s) 104 generates AI-suggested content or values within one or more components of the recipe, such as the bill of materials or the bill of equipment. For example, the production model(s) 104 can perform the component-based analysis of the recipe using the batch record(s) 115 and/or user input(s) (e.g., via the MES control application(s) 114) that identify information such as a recipe name and a description of the end product to be manufactured. Based on the input(s), the production control circuitry 102 executes the production model(s) 104 to generate, for example, a bill of materials that identifies materials to be used to produce the product. As disclosed herein, the production control circuitry 102 can identify materials to be added to the bill of materials based on the name of the recipe, the product description, the content in the batch record(s) 115, etc. The production control circuitry 102 compares the materials identified as a result of execution of the production model(s) 104 to available materials in the material repository 112. Based on the comparison, the production control circuitry 102 can output a proposed list that includes suggested materials for the bill of materials based on the recipe to be created. In some examples, a user can confirm or reject the suggested materials for the bill of materials. In some examples, the production control circuitry 102 automatically adds the suggested materials to a final bill of materials for the digital recipe 117 if, for example, a confidence threshold is satisfied.

When proposing materials for the bill of materials using the production model(s) 104, the example production control circuitry 102 of FIG. 1 also considers one or more variables, factors, and/or conditions associated with the process control system 106 as indicated in a data fabric 118. The data fabric 118 (e.g., a contextual memory graph) can be stored locally or in a cloud. The data fabric 118 obtains information from one or more of the data source(s) 111, the MES control application(s) 114, the process control system 106 (e.g., the field device(s) 110). The information can include, for example, inventory information for consumables (e.g., inventory information for single use equipment such as bags or consumable materials such as reagents), equipment status information (e.g., available equipment, equipment undergoing maintenance, etc.). The data fabric 118 stores the information and, in some examples, relationships or other contextual information about the available resources for the manufacturing process (e.g., relationships indicating which machines perform certain functions for certain materials).

Similarly, the production model(s) 104 can use user input(s) (e.g., end product description) and/or content in the batch record(s) 115 to generate a bill of equipment for the digital recipe 117 that identifies equipment (e.g., field device(s) 110) to be used to generate the product. The production control circuitry 102 compares the equipment identified as a result of execution of the production model(s) 104 to available equipment in the process control system 106 based on, for example, device availability and maintenance schedules identified in the data fabric 118. In some examples, a user can confirm or reject the suggested equipment for the bill of equipment. In some examples, the production control circuitry 102 automatically adds the suggested equipment to a final bill of equipment for the digital recipe 117 if, for example, the equipment is identified as available per the status information in the data fabric 118.

Thus, in the example of FIG. 1, the production control circuitry 102 can adjust the outputs of the production model(s) 104 based on the information stored in the data fabric 118 so that the results provided by the production control circuitry 102 are contextually relevant to the manufacturing process and the process control system 106 that implements the manufacturing process. In the example of FIG. 1, the output(s) (e.g., the digital recipe 117, a bill of materials of the recipe 117) generated by the production control circuitry 102 can be provided to the MES control application(s) 114 and/or the control device(s) 108 The control device(s) 108 can implement the manufacturing process based on the AI-driven outputs.

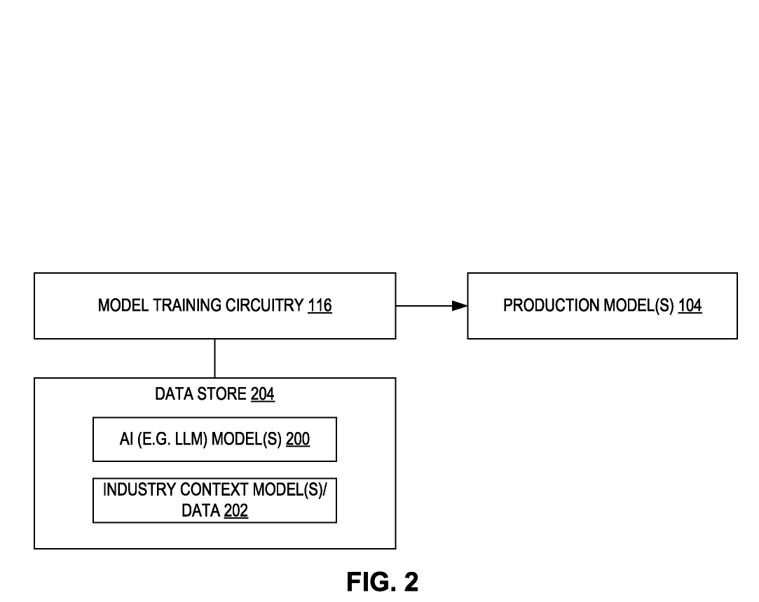

FIG. 2 is a block diagram of an example implementation of the model training circuitry 116 of FIG. 1 to train the production model(s) 104 for use by the production control circuitry 102 (FIG. 1). The model training circuitry 116 of FIG. 2 may be instantiated (e.g., creating an instance of, bring into being for any length of time, materialize, implement, etc.) by programmable circuitry. For example, programmable circuitry may be implemented by a Central Processor Unit (CPU) executing first instructions, a field programmable gate array, a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc. Additionally or alternatively, the model training circuitry 116 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) (e.g., another form of programmable circuitry) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

Artificial intelligence (AI), including machine learning (ML), deep learning (DL), and/or other artificial machine-driven logic, enables machines (e.g., computers, logic circuits, etc.) to use a model to process input data to generate an output based on patterns and/or associations previously learned by the model via a training process. For instance, the model may be trained with data to recognize patterns and/or associations and follow such patterns and/or associations when processing input data such that other input(s) result in output(s) consistent with the recognized patterns and/or associations.

Many different types of machine learning models and/or machine learning architectures exist. In examples disclosed herein, a large language model is used. Using a large language model enables the model being trained to understand and output text (e.g., components of a recipe based on text in a batch record, materials for a bill of materials). In general, machine learning models/architectures that are suitable to use in the example approaches disclosed herein will be generative AI models or genetic AI models. However, other types of machine learning models could additionally or alternatively be used.

In the example of FIG. 2, the model training circuitry 116 uses AI model(s) 200 (e.g., large language model(s)) as well as industry context model(s) or other data 202 to train the production model(s) 104. The industry context model(s)/data 202 can include, for example, pre-trained language models for terminology commonly used in an industry such as the pharmaceutical industry (e.g., a BioBERT model). For example, the natural language processing provided by the LLM model(s) 200 can be supplemented or amended based on the industry context model(s)/data 202. The industry context model(s)/data 202 can also include information such as industry regulations (e.g., drug safety standards). Thus, the production model(s) 104 can be customized for the industry in which the model(s) 104 are to be deployed. The model(s) 200, 202 can be stored in a data store 204 accessible by the model training circuitry 116.

Some examples disclosed herein are based on generative AI to generate, for example, a bill of materials based on the trained production model(s) 104. In some examples, the AI protocols used herein include an agent with particular specialties, such as a recipe author agent or a regulatory compliance agent, and an orchestrator agent to manage the agents.

In general, implementing a ML/AI system involves two phases, a learning/training phase and an inference phase. In the learning/training phase, a training algorithm is used to train a model to operate in accordance with patterns and/or associations based on, for example, training data. In general, the model includes internal parameters that guide how input data is transformed into output data, such as through a series of nodes and connections within the model to transform input data into output data. Additionally, hyperparameters are used as part of the training process to control how the learning is performed (e.g., a learning rate, a number of layers to be used in the machine learning model, etc.). Hyperparameters are defined to be training parameters that are determined prior to initiating the training process.

Different types of training may be performed based on the type of ML/AI model and/or the expected output. For example, supervised training uses inputs and corresponding expected (e.g., labeled) outputs to select parameters (e.g., by iterating over combinations of select parameters) for the ML/AI model that reduce model error. As used herein, labelling refers to an expected output of the machine learning model (e.g., a classification, an expected output value, etc.). Alternatively, unsupervised training (e.g., used in deep learning, a subset of machine learning, etc.) involves inferring patterns from inputs to select parameters for the ML/AI model (e.g., without the benefit of expected (e.g., labeled) outputs).

In examples disclosed herein, ML/AI models are trained using stochastic gradient descent. However, any other training algorithm may additionally or alternatively be used. In examples disclosed herein, training is performed until an acceptable (e.g., minimal) amount of error is achieved. In examples disclosed herein, training is performed locally or remotely relative to the process control system 106. Training is performed using hyperparameters that control how the learning is performed (e.g., a learning rate, a number of layers to be used in the machine learning model, etc.). In some examples re-training may be performed. Such re-training may be performed in response to user feedback.

Training is performed using training data. In examples disclosed herein, the training data originates from, for example, data that is specific to an industry in which the model is to be used (e.g., language commonly used in the pharmaceutical industry). In some examples, the training data includes historical or reference batch records and corresponding recipes generated for such historical batch records. In some examples, the training data includes historical bills of material or bills of equipment for known recipes. Because supervised training is used, the training data is labeled. For example, the portions of the batch records and recipes can be labeled to train the model(s) to divide batch records into sections that correspond to a recipe, to structure recipes by section, etc. Thus, the model(s) 104 are trained to deterministically retrieve or identify the sections that will define the recipe from the batch record(s).

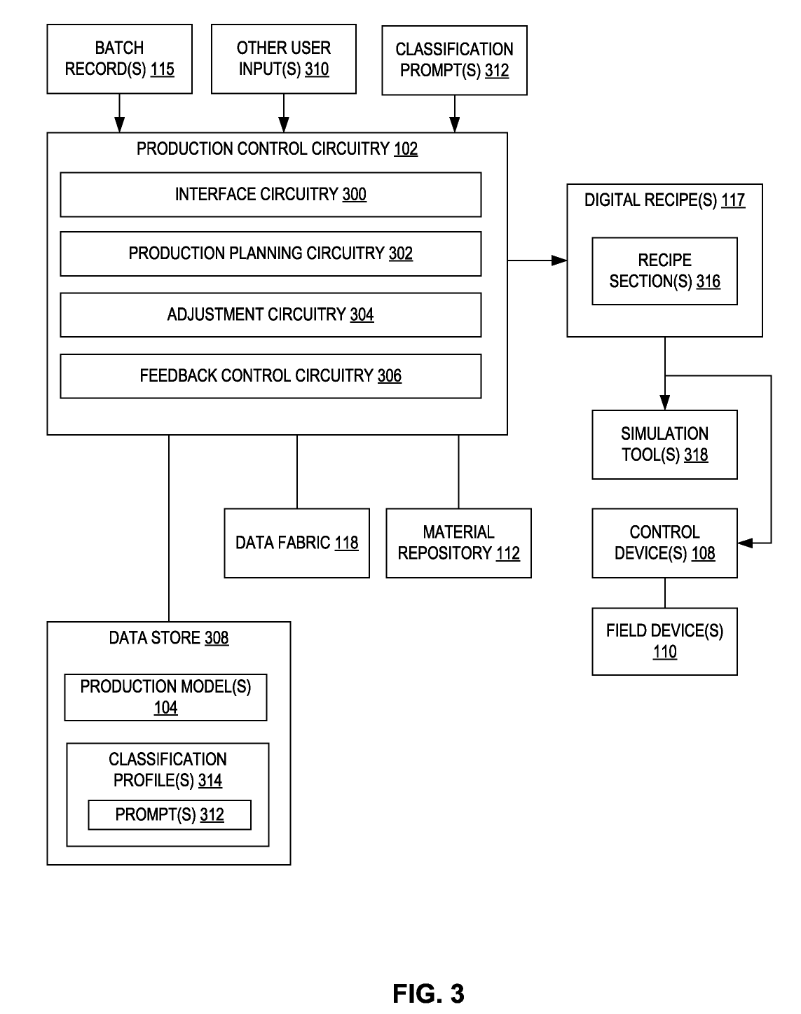

Once training is complete, the model(s) (e.g., the production model(s) 104) are deployed for use as executable constructs that process an input and provide an output based on the network of nodes and connections defined in the model(s). The model(s) are stored at a data store 308 (FIG. 3). The model(s) (e.g., the production model(s) 104) may then be executed by the production control circuitry 102.

Once trained, the deployed model(s) may be operated in an inference phase to process data. In the inference phase, data to be analyzed (e.g., live data) is input to the model(s), and the model(s) execute to create output(s). This inference phase can be thought of as the AI “thinking” to generate the output based on what it learned from the training (e.g., by executing the model(s) to apply the learned patterns and/or associations to the live data). In some examples, input data undergoes pre-processing before being used as an input to the machine learning model. Moreover, in some examples, the output data may undergo post-processing after it is generated by the AI model to transform the output into a useful result (e.g., a display of data, an instruction to be executed by a machine, etc.).

In some examples, output(s) of the deployed model(s) may be captured and provided as feedback. By analyzing the feedback, the accuracy of the deployed model(s) can be determined. If the feedback indicates that the accuracy of a deployed model is less than a threshold or other criterion, training of an updated model can be triggered using the feedback and an updated training data set, hyperparameters, etc., to generate an updated, deployed model. In some examples, the model training circuitry 116 performs post-training based on human reinforcement as part of the training process (e.g., after initial training) or based on end user feedback after deployment of the model(s) 104 (e.g., in the real-world environment).

FIG. 3 is a block diagram of an example implementation of the production control circuitry 102 of FIG. 1 to use AI for recipe creation for a manufacturing process. The production control circuitry 102 of FIG. 3 may be instantiated (e.g., creating an instance of, bring into being for any length of time, materialize, implement, etc.) by programmable circuitry. For example, programmable circuitry may be implemented by a Central Processor Unit (CPU) executing first instructions, a field programmable gate array, a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc. Additionally or alternatively, the production control circuitry 102 of FIG. 3 may be instantiated (e.g., creating an instance of, bring into being for any length of time, materialize, implement, etc.) by (i) an Application Specific Integrated Circuit (ASIC) and/or (ii) a Field Programmable Gate Array (FPGA) (e.g., another form of programmable circuitry) structured and/or configured in response to execution of second instructions to perform operations corresponding to the first instructions. It should be understood that some or all of the circuitry of FIG. 3 may, thus, be instantiated at the same or different times. Some or all of the circuitry of FIG. 3 may be instantiated, for example, in one or more threads executing concurrently on hardware and/or in series on hardware. Moreover, in some examples, some or all of the circuitry of FIG. 3 may be implemented by microprocessor circuitry executing instructions and/or FPGA circuitry performing operations to implement one or more virtual machines and/or containers.

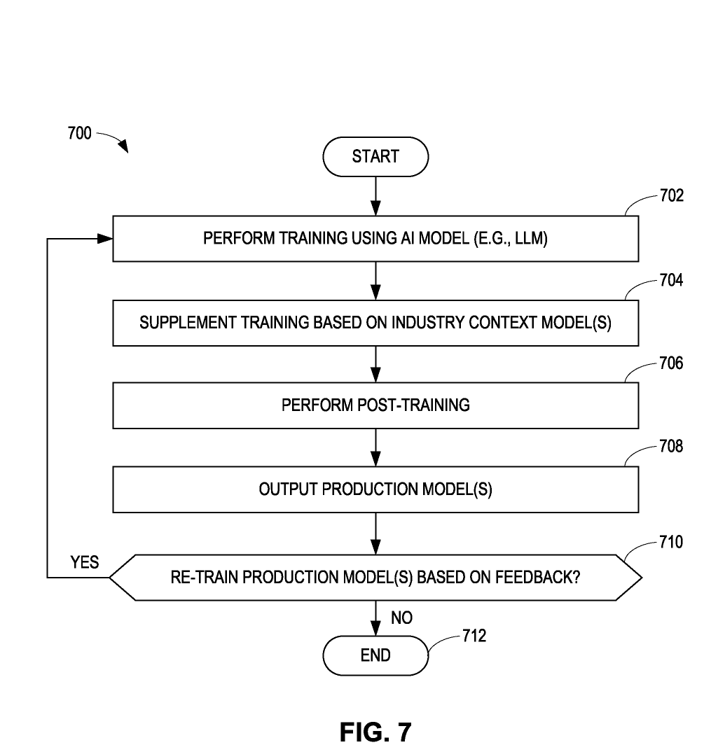

The example production control circuitry 102 includes interface circuitry 300, production planning circuitry 302, adjustment circuitry 304, and feedback control circuitry 306. In some examples, the interface circuitry 300 is instantiated by programmable circuitry executing interface instructions and/or configured to perform operations such as those represented by the flowchart of FIG. 7. In some examples, the production planning circuitry 302 is instantiated by programmable circuitry executing production planning instructions and/or configured to perform operations such as those represented by the flowchart of FIG. 7. In some examples, the adjustment circuitry 304 is instantiated by programmable circuitry executing adjustment instructions and/or configured to perform operations such as those represented by the flowchart of FIG. 7. In some examples, the feedback control circuitry 306 is instantiated by programmable circuitry executing feedback control instructions and/or configured to perform operations such as those represented by the flowchart of FIG. 7.

The interface circuitry 300 of the example production control circuitry 102 of FIG. 3 accesses batch record(s) 115 that are to be used to generate the digital recipe(s) 117. The interface circuitry 300 can access other user input(s) 310 such as a recipe name and description of an end product in connection with, for example, a request for a bill of materials. For example, the other user input(s) 310 can include a description of a drug type (e.g., a painkiller) in connection with a request for a recipe for such a drug type. The user input(s) can be provided via the MES control application(s) 114.

In some examples, the interface circuitry 300 receives classification prompt(s) 312 for the production model(s) 104 via the MES control application(s) 114. The classification prompt(s) 312 include user-defined guidance with respect to, for example, the analysis to be performed by the production model(s) 104 and the output(s) to be generated for a particular recipe. In some examples, the interface circuitry 300 obtains the classification prompt(s) 312 via classification profile(s) 314 stored in the data store 308. The classification profile(s) 314 can include previously generated prompt(s) 312 for different types of batch records and/or recipes. The prompt(s) 312 in the classification profile(s) 314 can be applied to the analysis of the batch record(s) 115 from which a (e.g., new) digital recipe 117 is to be generated. In some examples, the interface circuitry selects the classification profile(s) 314 based on the recipe to be generated and/or based on user input(s).

The classification prompt(s) 312 can be input by user(s) via the MES control application(s) 114 and can include instructions, descriptions, or other content to guide the execution of the production model(s) 104 for the recipe to be generated. For example, the classification prompt(s) 312 can include input(s) regarding the structure or format of the document corresponding to a batch record 115. For example, the classification prompt(s) 312 can identify section headings in the document, can identify the format of the content (e.g., identify that work instructions are formatted as a table including individual tasks or parameters), and can specify which signatures should be received. In some examples, the classification prompt(s) 312 are directed to particular section(s) of the batch record or the recipe to be generated. For example, the classification prompt(s) 312 can include instructions with respect to analysis of the work instructions section of the batch record 115 (e.g., instructing the model(s) 104 to include particular text and exclude other text for the work instruction section); the signature section (e.g., instructing the model(s) 104 to include labels such as “verified by” and “date” in the signature section); and the parameter section (e.g., instructing the model(s) 104 to classify certain data such as serial numbers and equipment identifiers as parameters).

The production planning circuitry 302 of the example production control circuitry 102 of FIG. 3 executes the production model(s) 104 using the batch record(s) 115 and the classification prompt(s) 312 as inputs. In some examples, the production planning circuitry 302 executes the production model(s) 104 based on the other user input(s) 310, such as a recipe name and a product description. The production model(s) 104 are stored in a data store 308 (which can be different from or the same as the data store 204 of FIG. 2).

The production model(s) 104 analyze a batch record 115 to sectionalize or otherwise divide the batch record 115 into sections of a recipe such as work instructions, parameters, bill of materials, bill of equipment, and signatures. Based on the machine-learning training and the classification prompt(s) 312, the production model(s) 104 extract content from the batch record 115 and classify the content to identify sections of the recipe. In particular, the production model(s) 104 generate a data structure for the digital recipe 117, where the data structure is defined by the recipe sections and complies with, for example, industry standards for digital recipe structures or formats (e.g., ISA standards).

After generating a proposed data structure of the digital recipe 117 including the recipe sections, the production model(s) 104 use the classification prompt(s) 312 to associate content in the batch record 115 with the sections of the recipe (e.g., work instructions, a bill of materials, a bill of equipment, parameters, etc.). As disclosed herein, the classification prompt(s) 312 can facilitate detection or classification of content by the production model(s) 104 with respect to the sections of the recipe 117. In classifying the content, the production model(s) 104 infer context for the content in the batch record. For example, a batch record can include an instruction stating: “mix the material three times with one minute between mixing.” The production model(s) 104 can infer that the mixing process should be performed three times even though the batch record 115 does not include three separate instructions regarding the mixing. The production model(s) 104 infer context from the content of the batch record to, for example, identify the context of the content and predict to which section the content should be associated with in the recipe.

The production model(s) 104 synthesize the results of the interference process to generate a recipe that includes components or sections 316 and content within each section 316 corresponding to, for example, work instructions, parameters, materials for the bill of materials, etc. For example, the production model(s) 104 classify content (e.g., instructions, numeric values) in the batch record 115 with respect to the sections 316 of the digital recipe 117 and generate content for the sections 316 of the recipe 117 corresponding to the classified content. As a result, the production model(s) 104 output a structured digital recipe 117 with sections 316 and instructions within each section 316 that are to be performed or values within each section that are to be accounted for during execution of the digital recipe 117.

The production planning circuitry 302 executes the production model(s) 104 for the one or more batch records 115 that are to be analyzed to generate the recipe 117. In some examples, the production planning circuitry 302 synthesizes outputs across two or more batch records 115 to form the digital recipe 117. In some examples, the production planning circuitry 302 removes redundancies between the outputs of the production model(s) 104 for the respective batch records 115 during the synthesis process.

In some examples, prior to outputting the digital recipe 117 for implementation by the process control system 106, the digital recipe 117 is presented via the MES control application(s) 114 for user review. In some examples, the user can adjust the proposed digital recipe via the MES control application(s) 114. For example, the user can reorganize instructions within a section, re-assign an instruction between sections, etc. In some examples, the user adjustments to the digital recipe 117 are used to re-train the production model(s) 104 and/or to score (e.g., rank) the classification profile(s) 314 based on metrics such as accuracy. In some examples, the classification profile(s) 314 can be ranked with respect to, for example, accuracy of the respective profile 314 for different types of recipes or products to be manufactured. In some such examples, the interface circuitry 300 selects a classification profile 314 (including associated prompt(s) 312) to be used by the production planning circuitry 302 in response to inputs identifying the recipe type, end product, etc.

In some examples, the adjustment circuitry 304 of the example production control circuitry 102 identifies or flags one or more sections 316 of the digital recipe 117 based on information in the data fabric 118. For example, the adjustment circuitry 304 can flag materials in the recipe 117 that are not available or have low inventory. In some such examples, the adjustment circuitry 304 instructs the production planning circuitry 302 to re-execute the production model(s) 104 to, for example, identify alternative materials.

The interface circuitry 300 outputs the digital recipe 117 (e.g., a user-approved digital recipe 117) to the MES control application(s) 114 (e.g., for presentation) and/or the control device(s) 108 for use in controlling the manufacturing process associated with the recipe. In some examples, the interface circuitry 300 causes the digital recipe 117 to be integrated into control process simulations performed by simulation tool(s) 318 as part of a recipe validation and/or testing process, where the simulation tool(s) 318 can be executed at the workstation 113 and/or the control device(s) 108. Thus, the digital recipe 117 is provided to (e.g., pushed to) components of the process control system 106 to facilitate manufacturing of the end product.

In some examples, the production planning circuitry 302 executes the production model(s) 104 to generate (e.g., predict, suggest, propose) content within a component or section 316 of the recipe. For example, the production planning circuitry 302 can execute the production model(s) 104 to identify (e.g., predict, suggest, propose) materials to be added to the bill of material and/or equipment to be added to the bill of equipment. In some examples, the production planning circuitry 302 uses AI to generate content (e.g., a bill of materials) for the recipe 117 based on user input(s) received via the MES control application(s) 114. In some examples, the production planning circuitry 302 executes the production model(s) 104 to generate recipe content (e.g., a bill of materials) without user input upon detecting that, for example, content for one or more components of the digital recipe 117 is missing from the batch record(s) 115. In some such examples, to inform the user, the production planning circuitry 302 flags or otherwise identifies that one or more of the recipe sections 316 is missing in the digital recipe 117 and that the AI-models were used to suggest content.

For example, to generate a bill of material, the production planning circuitry 302 executes the production model(s) 104 based on input(s) such as the batch record(s) 115, the other user input(s) 310 identifying end product, etc. As a result of execution of the production model(s) 104, the production planning circuitry 302 identifies (e.g., predicts, suggests, proposes) materials to be added to the bill of materials. The production planning circuitry 302 searches the material repository 112 to identify available materials in the repository 112 that match or likely match the materials identified by the production model(s) 104 (e.g., based on content in the batch record(s) 115). In some examples, a name of a material suggested by the production model(s) 104 may not match the name that a manufacturer uses for the material in the material repository 112. For example, the production model(s) 104 may suggest “salt” as a material for the bill of materials while the material repository 112 lists “sodium chloride,” or vice versa. When searching the material repository 112, the production planning circuitry 302 executes the model(s) 104 to identify materials that are exact matches as well as likely or related matches. For example, for the material “salt,” the production model(s) 104 can identify materials in the material repository 112 labeled as “NaCL,” “sodium chloride,” and/or “Morton^{TM} Salt” as likely matches to “salt.” The production planning circuitry 302 determines (e.g., via the production model(s) 104) a confidence level that a material in the material repository 112 (e.g., “sodium chloride”) matches the material suggested by the model(s) 104 (e.g., “salt”). The production planning circuitry 302 assigns confidence level(s) to the material(s) in the material repository 112 that are identified as potential matches for the AI-generated result(s). Thus, the example production planning circuitry 302 of FIG. 3 uses AI to identify materials for a recipe and map the identified materials to available materials in the material repository 112.

In some examples, the production planning circuitry 302 is unable to identify a match (e.g., an exact match or a likely match) for the AI-suggested material in the material repository 112. In such examples, the production planning circuitry 302 can execute the production model(s) 104 to identify material(s) that may be used in place of the missing material (e.g., substitute material(s)) and to verify that the substitute material(s) are available in the material repository 112. In some examples, the production model(s) 104 can suggest creating a material using two or more materials identified as available in the material repository 112 to replace the missing material.

In some examples, the adjustment circuitry 304 adjusts one or more of the outputs of the production model(s) 104 with respect to the bill of materials, the bill of equipment, or other sections 316 of the recipe 117 based on information in the data fabric 118. For example, the data fabric 118 can include rules and/or information associated with inventory of consumables for use with the material(s) (e.g., single-use items such as packaging); operational status of one or more field device(s) 110 (FIG. 1); workflows (e.g., preferred workflows, alternative workflows); preferences for materials or combinations of materials as set forth in an electronic laboratory notebook (one of the data sources 111), etc. The adjustment circuitry 304 can determine if equipment for processing a particular material identified by the production model(s) 104 is not available and instruct the production planning circuitry 302 to re-execute the model(s) 104 to identify other material(s). Thus, in some examples, although the AI production model(s) 104 may suggest a material based on the recipe name, information in the data fabric 118 can cause the adjustment circuitry 304 to determine that the material(s) should be modified in view of conditions in the process control environment and/or rules identified in the data fabric 118 and to facilitate re-execution of the production model(s) 104.

In some examples, prior to outputting, for example, a bill of materials and/or the recipe 117 including the AI-generated bill of materials, the production planning circuitry 302 outputs a proposed material list including, for example, (a) materials suggested by the production model(s) 104, (b) any materials in the material repository 112 that match the suggested material(s) with assigned confidence level(s) for the respective matches; (c) any missing materials for which a match was not identified in the material repository 112; and (d) any proposed substitutions for the missing material(s). In some examples, the interface circuitry 300 outputs the proposed material list for presentation via an interface of the MES control application(s) 114 at the workstation 113. A user (e.g., a recipe author) can confirm or modify the materials to be added to the bill of materials based on the information in the proposed material list, such as the confidence levels for the matching materials. The production planning circuitry 302 generates the bill of materials based on, for example, user input(s) confirming the materials in the proposed material list that are to be included in the bill of materials. In some examples, the production planning circuitry 302 automatically adds materials from the proposed material list that satisfy confidence level threshold(s) to the bill of materials. The confidence level threshold(s) and automatic addition of materials to the bill of materials can be based on user setting(s) defining permissions for the production planning circuitry 302. The interface circuitry 300 can output the bill of materials for inclusion in the digital recipe 117 for use in controlling the manufacturing process associated with the recipe.

In some examples, after generating a digital recipe 117 and/or components thereof (e.g., a bill of materials), the production planning circuitry 302 can execute the production model(s) 104 to generate additional (e.g., alternative or adjusted) version(s) of the digital recipe 117 (e.g., to refine the digital recipe 117, to identify improvements to the recipe 117). In some examples, the production planning circuitry 302 generates the additional version(s) of the recipe 117 in response user input(s) requesting modification to one or more recipe sections 316 (e.g., parameters). In some examples, the production planning circuitry 302 generates the additional version(s) of the recipe 117 in response to adjustments the classification prompt(s) 312. In some examples, the production planning circuitry 302 generates the additional version(s) of the recipe 117 in response to, for example, identifying the availability of other equipment or materials in the process control system 106 and/or based on training involving recipes for similar end products (in sone such examples, the production planning circuitry 302 generates the additional version(s) of the recipe 117 without user input). In some examples, the production planning circuitry 302 generates the additional version(s) of the recipe 117 using one or more of the classification profile(s) 314, information in the data fabric 118, information in the material repository 112, additional batch records 115 (e.g., different than the batch record(s) 115 used to generate the initial digital recipe 117), etc. as inputs to the production model(s) 104. In some examples, the production planning circuitry 302 outputs the additional version(s) of the recipe 117 for execution by the process control system 106 after, for example, user approval and/or validation of the adjusted version(s) of the recipe 117 via the simulation tool(s) 318.

The feedback control circuitry 306 of the example production control circuitry 102 can detect user input(s) associated with the proposed recipe data structure and/or sections, the proposed material list, etc., and provide the user input(s) as feedback to train the production model(s) 104. For example, if a user rejects a material suggested by the production model(s) 104 and/or rejects a matching material identified by the model(s) 104 from the material repository 112, the feedback control circuitry 306 can communicate such decision(s) to the model training circuitry 116 for re-training of the model(s) 104. If the user accepts a material or a substitute material identified by the production model(s) 104, the feedback control circuitry 306 can classify the acceptance of the model output(s) as feedback to further train the model(s) 104.

While an example manner of implementing the production control circuitry 102 of FIG. 1 is illustrated in FIG. 3, one or more of the elements, processes, and/or devices illustrated in FIG. 3 may be combined, divided, re-arranged, omitted, eliminated, and/or implemented in any other way. Further, the example interface circuitry 300, the example production planning circuitry 302, the example adjustment circuitry 304, the example feedback control circuitry 306, and/or, more generally, the example production control circuitry 102 of FIG. 3, may be implemented by hardware alone or by hardware in combination with software and/or firmware. Thus, for example, any of the example interface circuitry 300, the example production planning circuitry 302, the example adjustment circuitry 304, the example feedback control circuitry 306, and/or, more generally, the example production control circuitry 102, could be implemented by programmable circuitry, processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), vision processing units (VPUs), and/or field programmable logic device(s) (FPLD(s)) such as FPGAs in combination with machine-readable instructions (e.g., firmware or software). Further still, the example production control circuitry 102 of FIG. 3 may include one or more elements, processes, and/or devices in addition to, or instead of, those illustrated in FIG. 3, and/or may include more than one of any or all of the illustrated elements, processes, and devices.

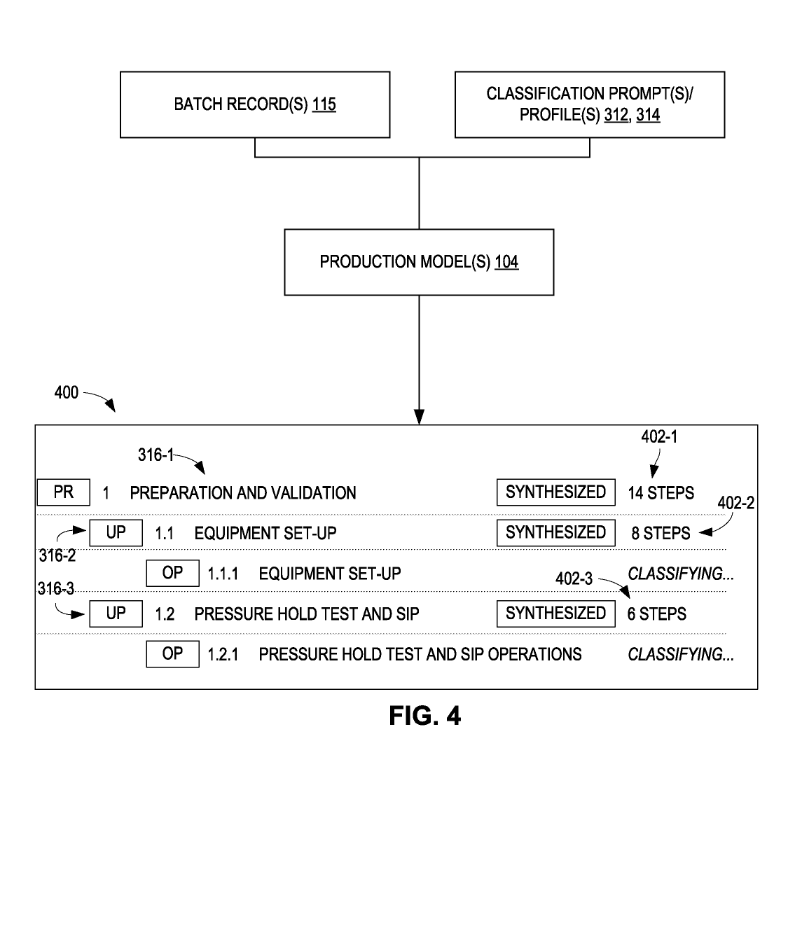

FIG. 4 illustrates an example recipe data structure 400 for a digital recipe 117, where the recipe data structure 400 is generated as a result of the execution of the production model(s) 104 using the batch record(s) 115 and the classification prompt(s) 312 and/or profile(s) 314 as inputs. As shown in FIG. 4, the recipe data structure 400 includes recipe sections 316 (where three recipe sections 316-1, 316-2, 316-3 are shown in FIG. 4). Within the sections 316, the production model(s) 104 identifies content corresponding to instructions, steps, parameters, etc. for the respective sections 316 as a result of synthesis of the classifications of the batch record content generated during the inference process (e.g., content 402-1 for section 316-1 corresponding to 14 steps; content 402-2 for section 316-2 corresponding to 8 steps; content 402-3 for section 316-3 corresponding to 6 steps). As disclosed herein, in some examples, content for one or more of the sections 316, such as the bill of materials, can be generated by the production model(s) 104 as proposed content to be included in the recipe 117.

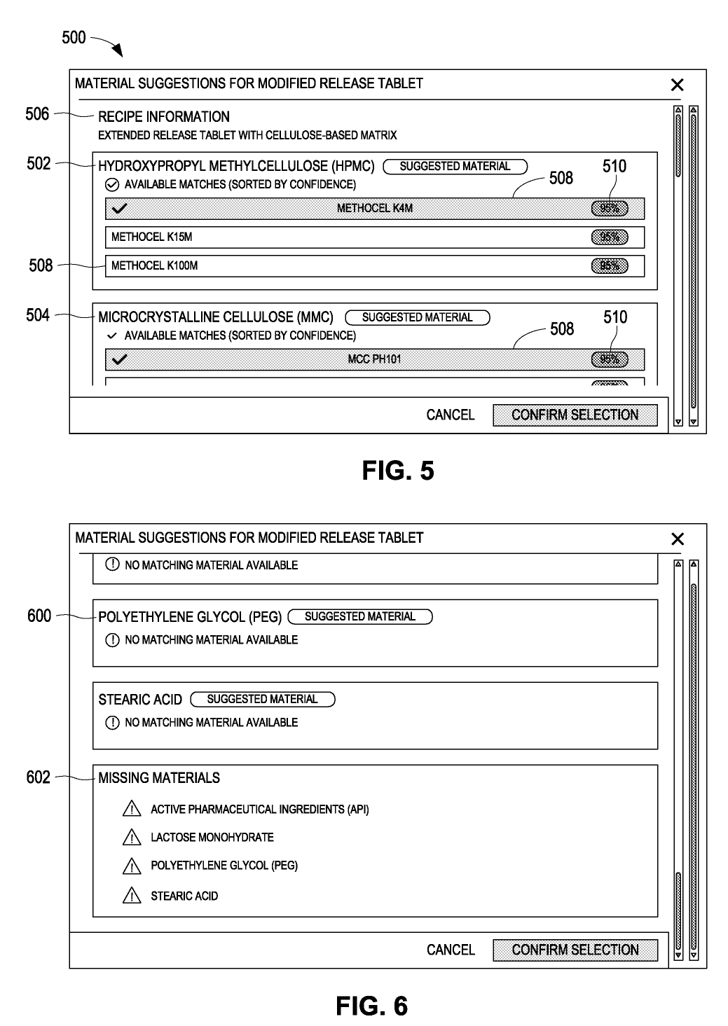

FIG. 5 illustrates a first portion of an example proposed material list 500 generated by the production planning circuitry 302 of example the production control circuitry 102 of FIG. 3. The proposed material list 500 can be output for presentation to a user in connection with generating a bill of materials for a digital recipe 117. In this example, the production model(s) 104 identified suggested materials 502, 504 based on recipe information 506 provided by a user (e.g., a request for an “extended release tablet with cellulose-based matrix”). Additionally or alternatively, the production model(s) 104 can identify suggested materials 502, 504 based on analysis of batch record(s) 115. As shown in FIG. 5, the proposed material list 500 includes suggested materials 502, 504 resulting from execution of the model(s) 104 and any available matching material(s) 508 that have been identified based on the mapping of the suggested materials 502, 504 to the material repository 112. The proposed material list 500 displays confidence levels 510 assigned to the materials identified as matches. The available matching material(s) 508 can be sorted based on the confidence levels 510. In this example, a user can confirm which of the matching material(s) 508 should be added to the final bill of materials.

FIG. 6 illustrates a second portion of the example proposed material list 500 of FIG. 5. The portion of the example proposed material list 500 shown in FIG. 6 identifies suggested materials 600 for the materials for which the model(s) 104 have not identified any available matches in the material repository 112. The proposed material list 600 can also identify missing materials 602.

FIG. 7 is a flowchart representative of example machine-readable instructions and/or example operations 700 that may be executed, instantiated, and/or performed by programmable circuitry to train the production model(s) 104. The example machine-readable instructions and/or the example operations 700 of FIG. 6 begin at block 702, at which the model training circuitry 116 performs training using an AI model 200 such as a large language model. At block 704, the model training circuitry 116 supplements the training performed at block 702 with training based on industry-specific context model(s)/data 202 (e.g., model(s) based on language used in a particular industry, such as the pharmaceutical industry). At block 706, the model training circuitry 116 can perform post-training to refine the production model(s) 104, which can include reinforcement based on human feedback. At block 708, the model training circuitry 116 outputs the production model(s) 104. At block 710, the model training circuitry 116 re-trains the production model(s) 104 based on feedback provided by the feedback control circuitry 306 of FIG. 3. The operations 700 end at block 712 when no further training is to be performed.

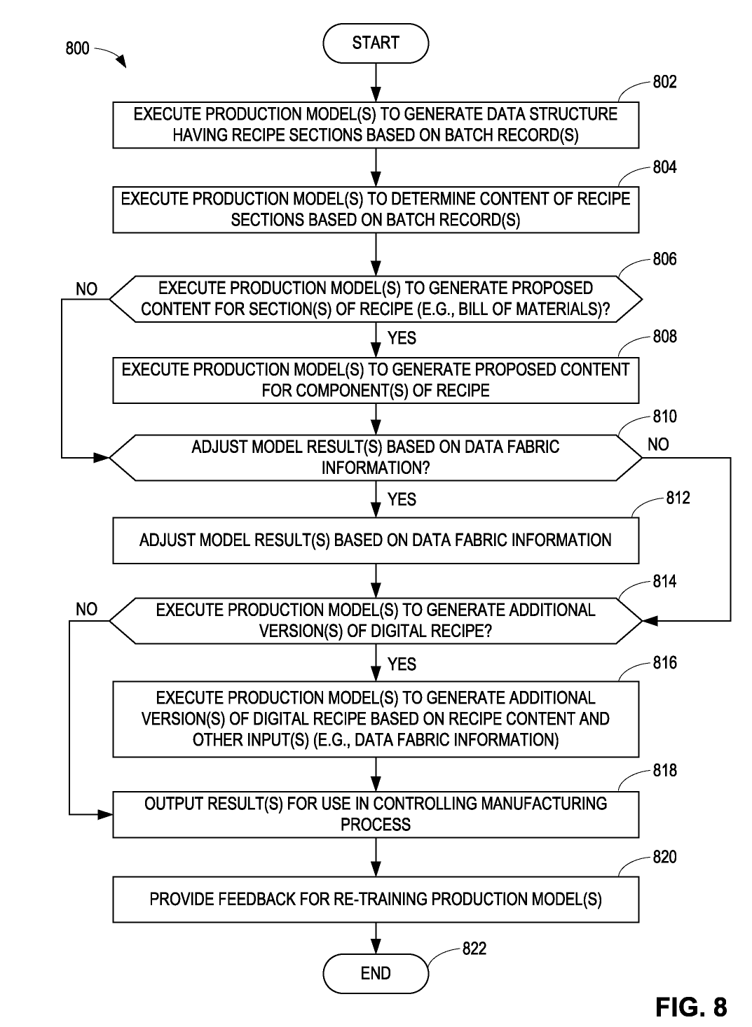

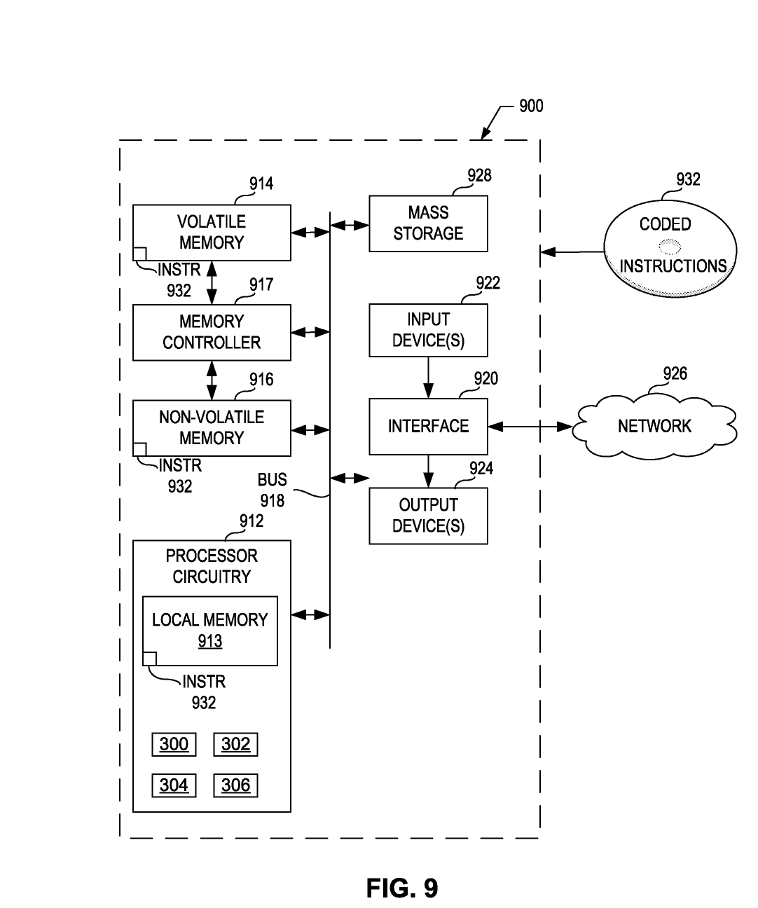

A flowchart representative of example machine-readable instructions, which may be executed by programmable circuitry to implement and/or instantiate the production control circuitry 102 of FIG. 3 and/or representative of example operations which may be performed by programmable circuitry to implement and/or instantiate the production control circuitry 102 of FIG. 3 is shown in FIG. 8. The machine-readable instructions may be one or more executable programs or portion(s) of one or more executable programs for execution by programmable circuitry such as the programmable circuitry 912 shown in the example processor platform 900 discussed below in connection with FIG. 9 and/or may be one or more function(s) or portion(s) of functions to be performed by example programmable circuitry (e.g., an FPGA). In some examples, the machine-readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer-readable and/or machine-readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer-readable and/or machine-readable medium may program and/or be executed by programmable

circuitry located in one or more hardware devices, but the entire program and/or parts thereof could alternatively be executed and/or instantiated by one or more hardware devices other than the programmable circuitry and/or embodied in dedicated hardware. The machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer-readable storage medium may include one or more mediums. Further, although the example program is described with reference to the flowchart(s) illustrated in FIG. 8, many other methods of implementing the example production control circuitry 102 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g.,

a single-core processor (e.g., a single core CPU), a multi-core processor (e.g., a multi-core CPU, an XPU, etc.)). As used herein, programmable circuitry includes any type(s) of circuitry that may be programmed to perform a desired function such as, for example, a CPU, a GPU, a VPU, and/or an FPGA. The programmable circuitry may include one or more CPUs, one or more GPUs, one or more VPUs, and/or one or more FPGAs located in the same package (e.g., the same integrated circuit (IC) package or in two or more separate housings), one or more CPUs, GPUs, VPUs, and/or one or more FPGAs in a single machine, multiple CPUs, GPUs, VPUs, and/or FPGAs distributed across multiple servers of a server rack, and/or multiple CPUs, GPUs, VPUs, and/or FPGAs distributed across one or more server racks. Additionally or alternatively, programmable circuitry may include a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc., and/or any combination(s) thereof in any of the contexts explained above. As used herein, the term “circuitry” refers to at least one “circuit.” Thus, circuitry refers to a circuit or a system of circuits. As used herein, programmable circuitry includes and/or corresponds to at least one programmable circuit.

The machine-readable instructions described herein may be stored in one or more of a compressed format, an encrypted format, a fragmented format, a compiled format, an executable format, a packaged format, etc. Machine-readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine-readable instructions may be fragmented and stored on one or more storage devices, disks, and/or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine-readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine-readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions and/or the corresponding program(s) can be executed in whole or in part. Thus, machine readable, computer readable and/or machine-readable media, as used herein, may include instructions and/or program(s) regardless of the particular format or state of the machine-readable instructions and/or program(s).

The machine-readable instructions described herein can be represented by any past, present, or future instruction language, scripting language, programming language, etc. For example, the machine-readable instructions may be represented using any of the following languages: C, C++, Java, C-Sharp, Perl, Python, JavaScript, HyperText Markup Language (HTML), Structured Query Language (SQL), Swift, etc.

As mentioned above, the example operations of FIG. 8 may be implemented using executable instructions (e.g., computer-readable and/or machine-readable instructions) stored on one or more non-transitory computer-readable and/or machine-readable media. As used herein, the terms non-transitory computer-readable medium, non-transitory computer-readable storage medium, non-transitory machine-readable medium, and/or non-transitory machine-readable storage medium are expressly defined to include any type of computer-readable storage device and/or storage disk and to exclude propagating signals and to exclude transmission media. Examples of such non-transitory computer-readable medium, non-transitory computer-readable storage medium, non-transitory machine-readable medium, and/or non-transitory machine-readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer-readable storage device” and “non-transitory machine-readable storage device” are defined to include any physical (mechanical, magnetic, and/or electrical) hardware to retain information for a time period, but to exclude propagating signals and to exclude transmission media. Examples of non-transitory computer-readable storage devices and/or non-transitory machine-readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer-readable instructions, machine-readable instructions, etc., and/or manufactured to execute computer-readable instructions, machine-readable instructions, etc.

FIG. 8 is a flowchart representative of example machine-readable instructions and/or example operations 800 that may be executed, instantiated, and/or performed by programmable circuitry to use AI to generate outputs to control a manufacturing process, such as a digital recipe 117 and/or components 316 thereof, such as a bill of materials. The example machine-readable instructions and/or the example operations 800 of FIG. 8 begin at block 802, at which the production planning circuitry 302 of FIG. 3 executes the production model(s) 104 to identify the components or sections 316 of the digital recipe 117 and generate a receipt data structure 400 based on the batch record(s) 115. At block 804, the production planning circuitry 302 of FIG. 3 executes the production model(s) 104 to determine content 402 (e.g., instructions, values) of the recipe sections 316 based on the batch record(s) 115. In executing the production model(s) 104, the production planning circuitry 302 of FIG. 3 can use the classification prompts and/or profiles as inputs.

In some examples (block 806), the production planning circuitry 302 of FIG. 3 executes the production model(s) 104 to generate proposed content for one or more section(s) 316 of the digital recipe 117, such as a bill of materials. In some examples, the production planning circuitry 302 generates the proposed content in response to detecting that the content is missing from the digital recipe 117 that is generated from the batch record(s) and/or based on user inputs. As a result of the execution of the production model(s) 104, the production planning circuitry 302 can generate suggested materials for a bill of materials, generate suggested equipment for a bill of equipment, etc. (block 808).

At block 810, the adjustment circuitry 304 determines if the result(s) generated by the production model(s) 104 (e.g., the digital recipe 117, the proposed content for the bill of materials) should be adjusted based on information in the data fabric 118. For example, the adjustment circuitry 304 can determine that the result(s) generated by the production model(s) 104 should be adjusted based on inventory information stored in the data fabric 118 regarding consumables used by the process control system 106. In some examples, at block 812, the adjustment circuitry 304 instructs the production planning circuitry 302 to re-execute the production model(s) 104 to adjust the result(s) in view of the information in the data fabric 118.

In some examples, the production planning circuitry 302 executes the production model(s) 104 to generate (e.g., predict, suggest, propose) additional version(s) of the digital recipe 117 based on the content in the digital recipe 117 and other input(s) such as information in the data fabric 118, information in the material repository 112, and/or additional batch record(s) 115 (blocks 814, 816). The additional version(s) of the digital recipe 117 can include AI-suggestions (refinements, improvements) to the digital recipe 117 based on the training of the production model(s) 104.

At block 818, the interface circuitry 300 outputs the result(s) (or adjusted result(s)) from execution of the production model(s) 104 for use in controlling a manufacturing process executed by the process control system 106. For example, the output(s) can include a digital recipe 117 (e.g., after validation using the simulation tool(s) 318); additional version(s) of the digital recipe(s) (e.g., after validation using the simulation tool(s) 318); a proposed material list 500; and/or a bill of materials 316 including materials selected from the proposed list 500 (e.g., as confirmed by a user or automatically added by the production planning circuitry 302 based on a confidence level for the matching material). The output(s) can be provided to the control device(s) 108 to control operation of the field device(s) 110 based on the output(s) (e.g., the digital recipe 117).

At block 820, the feedback control circuitry 306 provides feedback to the model training circuitry 116 for re-training the production model(s) 104 based on, for example, user input(s) confirming or rejecting the results from the model(s) 104. The example operations 800 end at block 822.

FIG. 9 is a block diagram of an example programmable circuitry platform 900 structured to execute and/or instantiate the example machine-readable instructions and/or the example operations of FIG. 8 to implement the production control circuitry 102 of FIG. 3. The programmable circuitry platform 900 can be, for example, a server, a personal computer, a workstation, a self-learning machine (e.g., a neural network), a mobile device (e.g., a cell phone, a smart phone, a tablet such as an iPad^{TM}), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 900 of the illustrated example includes programmable circuitry 912. The programmable circuitry 912 of the illustrated example is hardware. For example, the programmable circuitry 912 can be implemented by one or more integrated circuits, logic circuits, FPGAs, microprocessors, CPUs, GPUs, VPUs, DSPs, and/or microcontrollers from any desired family or manufacturer. The programmable circuitry 912 may be implemented by one or more semiconductor based (e.g., silicon based) devices. In this example, the programmable circuitry 912 implements example interface circuitry 300, the example production planning circuitry 302, the example adjustment circuitry 304, and the example feedback control circuitry 306.

The programmable circuitry 912 of the illustrated example includes a local memory 913 (e.g., a cache, registers, etc.). The programmable circuitry 912 of the illustrated example is in communication with main memory 914, 916, which includes a volatile memory 914 and a non-volatile memory 916, by a bus 918. The volatile memory 914 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 916 may be implemented by flash memory and/or any other desired type of memory device. Access to the main memory 914, 916 of the illustrated example is controlled by a memory controller 917. In some examples, the memory controller 917 may be implemented by one or more integrated circuits, logic circuits, microcontrollers from any desired family or manufacturer, or any other type of circuitry to manage the flow of data going to and from the main memory 914, 916.

The programmable circuitry platform 900 of the illustrated example also includes interface circuitry 920. The interface circuitry 920 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 922 are connected to the interface circuitry 920. The input device(s) 922 permit(s) a user (e.g., a human user, a machine user, etc.) to enter data and/or commands into the programmable circuitry 912. The input device(s) 922 can be implemented by, for example, an audio sensor, a microphone, a camera (still or video), a keyboard, a button, a mouse, a touchscreen, a trackpad, a trackball, an isopoint device, and/or a voice recognition system.

One or more output devices 924 are also connected to the interface circuitry 920 of the illustrated example. The output device(s) 924 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 920 of the illustrated example, thus, typically includes a graphics driver card, a graphics driver chip, and/or graphics processor circuitry such as a GPU.

The interface circuitry 920 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 926. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 900 of the illustrated example also includes one or more mass storage discs or devices 928 to store firmware, software, and/or data. Examples of such mass storage discs or devices 928 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine-readable instructions 932, which may be implemented by the machine-readable instructions of FIG. 8, may be stored in the mass storage device 928, in the volatile memory 914, in the non-volatile memory 916, and/or on at least one non-transitory computer-readable storage medium such as a CD or DVD which may be removable.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a,” “an,” “first,” “second,” etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein, integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that use artificial intelligence to control one or more aspects of a manufacturing process, such as recipe creation and/or content generation for components of the recipe, such as a bill of materials. Examples disclosed herein increase efficiency and reduce errors with respect to, for example, recipe creation in a manufacturing execution system by using artificial intelligence.

Example systems, apparatus, and methods for artificial intelligence control in manufacturing are disclosed. Further examples and combinations thereof include the following:

Example 1 includes a system including a control device associated with a process control system; machine-readable instructions; and at least one programmable circuit to execute the machine-readable instructions to execute an artificial intelligence (AI) model using a batch record to form a data structure including recipe sections and content within the respective recipe sections, the data structure defining a digital recipe; and cause the control device to operate one or more field devices in the process control system based on the digital recipe.

Example 2 includes any preceding clause(s) of Example 1, wherein a first section of the recipe sections is a bill of materials and one or more of the at least one programmable circuit is to execute the AI model to generate the content for the bill of materials.

Example 3 includes any preceding clause(s) of any one or more of Examples 1 and 2, wherein the content for the bill of materials includes a first material one or more of the at least one programmable circuit is to adjust the content for the bill of materials based on an availability of the first material in the process control system.

Example 4 includes any preceding clause(s) of any one or more of Examples 1–3, wherein one or more of the programmable circuit is to execute the AI model to generate the content for the bill of materials responsive to identifying missing information associated with the batch record.

Example 5 includes any preceding clause(s) of any one or more of Examples 1–4, wherein the digital recipe is a first version of the digital recipe and one or more of the programmable circuit is to execute the AI model to generate a second version of the digital recipe, the second version including adjust content for one or more of the recipe sections relative to the first version of the digital recipe.

Example 6 includes any preceding clause(s) of any one or more of Examples 1–5, wherein one or more of the at least one programmable circuit is to output the digital recipe to a simulation tool, the control device to operate one or more field devices in the process control system based on the digital recipe after testing of the digital recipe via the simulation tool.

Example 7 includes any preceding clause(s) of any one or more of Examples 1–6, wherein one or more of the at least one programmable circuit is to select a classification profile including a classification prompt for the AI model, one or more of the at least one programmable circuit to execute the AI model based on the classification prompt.

Example 8 includes an apparatus including interface circuitry to access a batch record; machine-readable instructions; and at least one programmable circuit to execute the machine-readable instructions to generate a data structure defining sections of a digital recipe for an end product based on content in the batch record; identify instructions corresponding to one or more the sections of the digital recipe based on the content in the batch record; and output the digital recipe including the instructions to a process control system.

Example 9 includes any preceding clause(s) of Example 8, wherein a first section of the sections of the digital recipe includes a bill of equipment and one or more of the at least one programmable circuit is to execute an artificial intelligence model to identify equipment in the process control system for the bill of equipment.

Example 10 includes any preceding clause(s) of any one or more of Examples 8 and 9, wherein a first section of the sections of the digital recipe includes a bill of material and one or more of the at least one programmable circuit is to execute an artificial intelligence (AI) model to identify material in the process control system for the bill of materials.

Example 11 includes any preceding clause(s) of any one or more of Examples 8–10, wherein one or more of the programmable circuit is to execute the AI model to identify the material for the bill of materials responsive to identification of missing information in the batch record.

Example 12 includes any preceding clause(s) of any one or more of Examples 8–11, wherein one or more of the at least one programmable circuit is to output the digital recipe to a simulation tool associated with the process control system.

Example 13 includes any preceding clause(s) of any one or more of Examples 8–12, wherein one or more of the at least one programmable circuit is to adjust one or more of the instructions based on an operational status of one or more devices associated with the process control system.

Example 14 includes a non-transitory machine-readable storage medium including machine-readable instructions to cause at least one programmable circuit to at least execute an artificial intelligence (AI) model to identify a first material for a bill of materials of a recipe; identify a corresponding matching material in a material repository for the first material, the material repository associated with a process control system; and generate an output for use with the process control system, the output including the first material and the matching material.

Example 15 includes any preceding clause(s) of Example 14, wherein the machine-readable instructions are to cause one or more of the at least one processor circuit to execute the AI model to determine a confidence level for the matching material, the output including the confidence level.

Example 16 includes any preceding clause(s) of any one or more of Examples 14 and 15, wherein the machine-readable instructions are to cause one or more of the at least one processor circuit to execute the AI model to identify a second material for the bill of materials; and re-execute the AI model to identify a different material than the second material based on data in a data fabric, the data fabric associated with the process control system.

Example 17 includes any preceding clause(s) of any one or more of Examples 14–16, wherein the machine-readable instructions are to cause one or more of the at least one processor circuit to identify the corresponding matching material in the material repository by performing a comparison of a name of the first material to a name of the matching material.

Example 18 includes any preceding clause(s) of any one or more of Examples 14–17, wherein the machine-readable instructions are to cause one or more of the at least one processor circuit to execute the AI model to identify a second material for the bill of materials; determine that the second material is missing in the material repository based on the name of the second material; and execute the AI model to identify a substitute material.

Example 19 includes any preceding clause(s) of any one or more of Examples 14–18, wherein the machine-readable instructions are to cause one or more of the at least one processor circuit to generate the bill of materials including the matching material responsive to a user input confirming selection of the matching material for inclusion in the bill of materials.

Example 20 includes any preceding clause(s) of any one or more of Examples 14–19, wherein the machine-readable instructions are to cause one or more of the at least one processor circuit to classify the selection of the matching material as feedback for training the AI model.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. A system comprising:
a control device associated with a process control system;
machine-readable instructions; and
at least one programmable circuit to execute the machine-readable instructions to:
execute an artificial intelligence (AI) model using a batch record to form a data structure including recipe sections and content within the respective recipe sections, the data structure defining a digital recipe; and
cause the control device to operate one or more field devices in the process control system based on the digital recipe.

2. The system of claim 1, wherein a first section of the recipe sections is a bill of materials and one or more of the at least one programmable circuit is to execute the AI model to generate the content for the bill of materials.

3. The system of claim 2, wherein the content for the bill of materials includes a first material one or more of the at least one programmable circuit is to adjust the content for the bill of materials based on an availability of the first material in the process control system.

4. The system of claim 2, wherein one or more of the programmable circuit is to execute the AI model to generate the content for the bill of materials responsive to identifying missing information associated with the batch record.

5. The system of claim 1, wherein the digital recipe is a first version of the digital recipe and one or more of the programmable circuit is to execute the AI model to generate a second version of the digital recipe, the second version including adjust content for one or more of the recipe sections relative to the first version of the digital recipe.

6. The system of claim 1, wherein one or more of the at least one programmable circuit is to output the digital recipe to a simulation tool, the control device to operate one or more field devices in the process control system based on the digital recipe after testing of the digital recipe via the simulation tool.

7. The system of claim 1, wherein one or more of the at least one programmable circuit is to select a classification profile including a classification prompt for the AI model, one or more of the at least one programmable circuit to execute the AI model based on the classification prompt.

8. An apparatus comprising:
interface circuitry to access a batch record;
machine-readable instructions; and
at least one programmable circuit to execute the machine-readable instructions to:
generate a data structure defining sections of a digital recipe for an end product based on content in the batch record;
identify instructions corresponding to one or more the sections of the digital recipe based on the content in the batch record; and
output the digital recipe including the instructions to a process control system.

9. The apparatus of claim 8, wherein a first section of the sections of the digital recipe includes a bill of equipment and one or more of the at least one programmable circuit is to execute an artificial intelligence model to identify equipment in the process control system for the bill of equipment.

10. The apparatus of claim 8, wherein a first section of the sections of the digital recipe includes a bill of material and one or more of the at least one programmable circuit is to execute an artificial intelligence (AI) model to identify material in the process control system for the bill of materials.

11. The apparatus of claim 10, wherein one or more of the programmable circuit is to execute the AI model to identify the material for the bill of materials responsive to identification of missing information in the batch record.

12. The apparatus of claim 8, wherein one or more of the at least one programmable circuit is to output the digital recipe to a simulation tool associated with the process control system.

13. The apparatus of claim 8, wherein one or more of the at least one programmable circuit is to adjust one or more of the instructions based on an operational status of one or more devices associated with the process control system.

14. A non-transitory machine-readable storage medium comprising machine-readable instructions to cause at least one programmable circuit to at least:
execute an artificial intelligence (AI) model to identify a first material for a bill of materials of a recipe;
identify a corresponding matching material in a material repository for the first material, the material repository associated with a process control system; and
generate an output for use with the process control system, the output including the first material and the matching material.

15. The non-transitory machine-readable storage medium of claim 14, wherein the machine-readable instructions are to cause one or more of the at least one processor circuit to execute the AI model to determine a confidence level for the matching material, the output including the confidence level.

16. The non-transitory machine-readable storage medium of claim 14, wherein the machine-readable instructions are to cause one or more of the at least one processor circuit to:
execute the AI model to identify a second material for the bill of materials; and
re-execute the AI model to identify a different material than the second material based on data in a data fabric, the data fabric associated with the process control system.

17. The non-transitory machine-readable storage medium of claim 14, wherein the machine-readable instructions are to cause one or more of the at least one processor circuit to identify the corresponding matching material in the material repository by performing a comparison of a name of the first material to a name of the matching material.

18. The non-transitory machine-readable storage medium of claim 17, wherein the machine-readable instructions are to cause one or more of the at least one processor circuit to:
execute the AI model to identify a second material for the bill of materials;
determine that the second material is missing in the material repository based on the name of the second material; and
execute the AI model to identify a substitute material.

19. The non-transitory machine-readable storage medium of claim 14, wherein the machine-readable instructions are to cause one or more of the at least one processor circuit to generate the bill of materials including the matching material responsive to a user input confirming selection of the matching material for inclusion in the bill of materials.

20. The non-transitory machine-readable storage medium of claim 19, wherein the machine-readable instructions are to cause one or more of the at least one processor circuit to classify the selection of the matching material as feedback for training the AI model.
